(19) United States
(12) Patent Application Publication
(10) Pub. No.: US 2014/0148553 A1
(43) Pub. Date: May 29, 2014

(54) REDUCED ALLERGENICITY OF NATURAL LATEX PRODUCT

(71) Applicants: Daniel J. Moncino, Scotts Valley, CA (US); Michael Greene, Santa Barbara, CA (US); Nigel Julian Keith Danvers, Brussels (BE); Qingchun Hu, Lompoc, CA (US)

(72) Inventors: Daniel J. Moncino, Scotts Valley, CA (US); Michael Greene, Santa Barbara, CA (US); Nigel Julian Keith Danvers, Brussels (BE); Qingchun Hu, Lompoc, CA (US)

(73) Assignee: IMERYS FILTRATION MINERALS, INC., San Jose, CA (US)

(21) Appl. No.: 13/988,379

(22) PCT Filed: Nov. 17, 2011
(86) PCT No.: PCT/US11/61198

§ 371 Date: Jan. 9, 2014

Related U.S. Application Data
(60) Provisional application No. 61/415,503, filed on Nov. 19, 2010.

(51) Int. Cl. C08L 7/02

(52) U.S. Cl. CPC C08L 7/02
USPC 525/154; 525/205

(57) ABSTRACT

Described herein is a reduced allergenicity natural latex rubber for use in such products as latex gloves and similar medical and consumer goods, and to methods of production and use thereof. In one aspect, a rubber composition may include a natural latex and a functionalized mineral filler. In another aspect, the mineral filler may include, for example, a diatomite.

### CLAIM OF PRIORITY/INCORPORATION BY REFERENCE

This PCT International Application claims the right of priority to, and hereby incorporates by reference herein in its entirety, U.S. Provisional Patent Application No. 61/415,503, filed Nov. 19, 2010, and also claims the benefits of any rights of priority that may be available to this application.

### FIELD OF THE INVENTION

The present invention relates to a reduced allergenicity natural latex rubber for use in such products as latex gloves and similar medical and consumer goods, and to methods of production and use thereof.

### BACKGROUND OF THE INVENTION

Natural rubber latex has been widely used as a protective material for over a century. In recent years, use has become even more widespread as a result of the global movement to take precautions against the spread of infectious diseases, specifically the AIDS virus. This, “Universal Precautions” policy outlined by the Centers for Disease Control, resulted in the widespread use of natural rubber latex in barrier articles like gloves and condoms. This widespread increase in the use of latex has in turn resulted in a dramatic increase in the incidence of allergy to latex protein.

Latex rubber in its natural form consists of polymeric, long chain molecules of repeating units of isoprene. When harvested from the rubber tree—Hevea brasiliensis—the liquid, sticky substance also contains low molecular weight soluble proteins like heavamine, and hevein.

In its natural state, natural latex can be undesirably soft and sticky. These properties are commonly modified by crosslinking the isoprene chains to one another by application of sulfur and heat in a process known as vulcanization, which increases strength and elasticity. Similar results can be achieved by applying accelerators such as thiurams, mercaptobenzothaizoles (MBTs), and carbamates which are commonly used in the production of latex for gloves.

Although the basic isoprene unit is non-antigenic, the protein components are thought to be a cause of IgE-mediated allergic reactions. By some estimates, the current prevalence of latex allergy among health care workers exceeds 15%. In addition to contact mediated allergic reactions, airborne latex particles can adhere to the cornstarch used to powder gloves and may increase risk of respiratory symptoms.

Despite these problems, natural latex rubber performs well as a barrier when used in gloves and similar applications and is significantly cheaper than most petroleum-based synthetic alternatives. Accordingly, it remains a preferred material in these applications despite the problems posed by allergenicity.

In addition to the problems presented by antigenic proteins, both natural and synthetic latex compositions can also exhibit undesirable odor characteristics due to the presence of various volatile organic and aromatic compounds, such as for example 4-phenylcyclohexane, as well as the coalescents and solvents used in production of the latex.

### SUMMARY OF THE INVENTION

In one aspect, the present invention provides a rubber composition comprising a natural latex and a functionalized mineral filler wherein said rubber has a soluble aqueous protein content of less than about 100 micrograms per gram as measured in accordance with ASTM D5712.

In another aspect, the present invention provides a method for decreasing the allergenicity of a natural latex comprising admixing a functionalized mineral filler with said natural latex.

In another aspect, the present invention provides latex glove comprising a natural latex and a functionalized mineral filler and having a soluble aqueous protein content of less than about 100 micrograms per gram as measured in accordance with ASTM D5712.

In yet another aspect, the invention provides a rubber composition comprising a natural or synthetic latex and a functionalized mineral filler wherein said rubber has a volatile organic content of less than about 3.0×10⁶ as measured by GC/mass spectrometry as described herein.

In one aspect, the mineral filler can include a diatomite. In another aspect, the mineral filler can include a perlite. In another aspect, the mineral filler can include a clay, such as a kaolin. In yet another aspect, the mineral filler can include mica.

In another aspect, the mineral filler can be selected from the group consisting of wollastonite, amorphous silicas, amorphous aluminas, alumina trihydrate, barite (Barium Sulfate), ground calcium carbonate, precipitated calcium carbonate, calcium sulfate, gypsum, carbon black, clay, chlorite, dolomite, feldspar, graphite, huntite, hydromagnesite, hydrotacite, magnesia, magnesite (magnesium carbonate), magnesium hydroxide, magnetite (Fe304), nepheline syenite, olivine, pseudoboehmites (forms of microcrystalline aluminum hydroxide), pyrophyllite, smectites (e.g., bentonite or montmorillonite), resins, titania, titanium dioxide (e.g., rutile), waxes, zeolites (e.g., Y-zeolites and dealuminated Y-zeolites), and zinc oxide.

In one aspect, the functionalized mineral filler can be present in the latex in an amount ranging from about 0.5 phr to about 10 phr. In another aspect, the functionalized mineral filler can be present in the latex in an amount ranging from about 1 phr to about 5 phr. in yet another aspect, the functionalized mineral filler can be present in the latex in an amount ranging from about 1 phr to about 3 phr.

In another aspect, the functional mineral filler includes a polymer as a functionalizing agent. For example, in one aspect the functionalized mineral filler can include a polyvinylpyrrolidone as a functionalizing agent. In another aspect, the functionalized mineral filler can include as a functional agent a polymer selected from a melamine formaldehyde, an epichlorohydrin, a polyamine, or a polyamide.

In another aspect, the functionalized mineral filler can include a precipitated silica or precipitated silicate as a functionalizing agent. In another aspect, the functionalized mineral filler can include a silane or a siloxane as a functionalizing agent.

In another aspect, the rubber can have a soluble aqueous protein content of less than about 100 micrograms per gram as measured in accordance with ASTM D5712. Alternatively, the rubber can have a soluble aqueous protein content of less than about 50 micrograms per gram, less than about 30 micrograms per gram or even less than about 20 micrograms per gram as measured in accordance with ASTM D5712.

### DETAILED DESCRIPTION OF THE INVENTION

In one aspect, the present invention provides a rubber composition comprising a natural latex and a functionalized mineral filler mineral filler wherein said rubber has a soluble aqueous protein content of less than about 100 micrograms per gram as measured in accordance with ASTM D5712.

In another aspect, the present invention provides a method for reducing protein allergenicity of natural latex rubber. This method suggests treating a mineral filler, such as for example diatomite, with a functionalizing agent, such as for example polyvinylpyrrolidone, and subsequently compounding with natural latex rubber, which can be used for manufacturing latex gloves.

In one aspect, the mineral filler is diatomaceous earth. In another aspect, the diatomaceous earth is natural, i.e., not thermally processed to a degree that would result in any significant crystallization of the amorphous silica phase of the diatomite. In another aspect, the diatomaceous earth is calcined. In yet another aspect, the diatomaceous earth is flux calcined. In a further aspect, diatomaceous earth is a commercially available super-fine diatomaceous earth product, such as but not limited to Superfloss™ available from Celite Corporation. In yet another aspect, the diatomaceous earth is CeITiX™, available from World Minerals Inc.

In a further aspect, the mineral filler is perlite. Perlite, as used herein, identifies any naturally occurring siliceous volcanic rock that can be expanded with heat treatment. In one aspect, perlite comprises between about 70% and about 74% silica, about 14% alumina, between about 2% and 6% water, and trace impurities. In one aspect, the perlite is ore. In another aspect, the perlite is expanded. In yet another aspect, the perlite is fine. In still another aspect, the perlite is Harborlite 635, a very fine grade of perlite available from Harborlite Corp., a subsidiary of World Minerals Inc.

In yet another aspect, the mineral filler is kaolin clay, which may also be referred to as china clay or hydrous kaolin. Exemplary kaolin clays include, but are not limited to, airfloat kaolin clay, water-washed kaolin clay, delaminated kaolin clay, and calcined kaolin clay.

In another aspect, the mineral filler is a synthetic alkaline earth silicate, such as a calcium silicate, a magnesium silicate, or a calcium-magnesium silicate. An exemplary synthetic alkaline earth silicate is Micro-Cel E, available from Advanced Minerals Corp., a subsidiary of World Minerals Inc.

In yet a further aspect, the mineral filler is a glass. In yet another aspect, the mineral filler is vermiculite. In yet a further aspect, the mineral filler is a phyllosilicate. In one aspect, the mineral filler is talc.

In one aspect, the mineral filler is mica. In another aspect, the mineral filler is mica with the general formula X2Y4-BZsO2O(OH1F)4, in which: X may be, but is not limited to, K, Na, Ca, Ba, Rb, or Cs; Y may be, but is not limited to, Al, Mg, Fe, Mn, Cr, Ti, and Li; and, Z may be, but is not limited to, Si, Al, Fe, and Ti.

In another aspect, the mineral filler is selected from the group consisting of, but not limited to, activated carbon, powders of polyethylene, fibers of polyethylene, fibers of polypropylene, high aspect ratio Wollastonite, low aspect ratio Wollastonite, amorphous silicas, amorphous aluminas, alumina trihydrate, barite (Barium Sulfate), smectites such as bentonite or montmorillonite, ground calcium carbonate, precipitated calcium carbonate, calcium sulfate, gypsum, carbon black, clay, chlorite, dolomite, feldspar, graphite, huntite, hydromagnesite, hydrotacite, magnesia, magnesite (magnesium carbonate), magnesium hydroxide, magnetite (Fe304), nepheline syenite, olivine, pseudoboehmites (forms of microcrystalline aluminum hydroxide), pyrophyllite, resins, titania, titanium dioxide (e.g., rutile), waxes, zeolites (e.g., Y-zeolites and dealuminated Y-zeolites), and zinc oxide.

In another aspect, the mineral filler is silica. Examples of silica include, but are not limited to, ground silica, novoculite silica, precipitated silica, fumed silica, and fumed amorphous silica. In a further aspect, the mineral filler is synthetic silica. Examples of synthetic silicas include, but are not limited to, silica gels, silica colloids, synthetic fused silica, and doped synthetic fused silica. In yet another aspect, the mineral filler is an aluminosilicate, with the basic structural composition AISiO4. Exemplary aluminosilicates include, but are not limited to, calcium aluminosilicate, sodium aluminosilicate, potassium aluminosilicate, zeolite, and kyanite.

In another aspect, the mineral filler can have an average particle size measured via Sedigraph 5100 ranging from about 0.1 microns to about 20 microns. For example, the mineral filler can have an average particle size ranging from about 0.2 to about 10 microns, from about 0.5 microns to about 5 microns, or from about 1 micron to about 3 microns.

In another aspect, the latex glove can comprise a natural latex and a functional particulate carrier of the general type disclosed in PCT Application WO2009045941A1. The at least one mineral filler can be used as the material subjected to at least one surface treatment, prior to exposure to an at least one active ingredient. Combinations of mineral fillers may be used. The skilled artisan will readily understand appropriate mineral fillers appropriate for use in the inventions described herein. In one aspect, the mineral filler is any inorganic substrate whose surface is capable of being modified through an at least one surface treatment to allow chemical bonding with at least one active ingredient.

In one aspect, at least one functionalizing agent can be used to modify the surface of the at least one mineral filler. In one aspect, the at least one functionalizing agent at least partially chemically modifies the surface of the at least one mineral filler by way of at least one surface treating agent. Chemical modification includes, but is not limited to, covalent bonding, ionic bonding, and “weak” intermolecular bonding such as van der Waals interactions. In another aspect, the at least one functionalizing agent at least partially physically modifies the surface of the at least one mineral filler. Physical modification includes, but is not limited to, roughening of the material surface, pitting the material surface, or increasing the surface area of the material surface. In a further aspect, the at least one functionalizing agent at least partially chemically modifies and at least partially physically modifies the surface of the at least one mineral filler. In yet another aspect, the at least one functionalizing agent results in a chemical or physical modification to the surface of the at least one mineral filler that results in increased retention of at least one active ingredient.

In one aspect, the functionalizing agent comprises at least one polymer that has protein absorptive properties. In one example, the functionalizing agent can be a polyvinylpyrrolidone or polymer of polyvinylpyrrolidone. In another example, the functionalizing agent can be selected from a melamine formaldehyde, an epichlorohydrin (e.g., polyamido polyamine epichlorohydrin, or any other polymeric polyamine or polyamide.

In another aspect, the functionalizing agent can comprise precipitated silica or a silicate, such as a magnesium silicate, calcium silicate, or a magnesium-calcium silicate. One example of a functionalized mineral filler that could be useful in the present invention for example includes Celite® Cynergy™ (available from Celite Corporation), which is a diatomite functionalized with via precipitation of silica onto the diatomite surfaces.

In another aspect the at least one functionalizing agent comprises at least one fatty acid. For example, at least one fatty acid can include an aliphatic carboxylic acid having at least 10 chain carbon atoms. For example, the fatty acids may be selected from one or more of stearic acid, palmitic acid, behenic acid, montanic acid, capric acid, lauric acid, myristic acid, isostearic acid and cerotic acid.

In another aspect the at least one functionalizing agent silanizes the at least one mineral filler, wherein the at least one surface treating agent is at least one siloxane. In general, siloxanes are any of a class of organic or inorganic chemical compounds comprising silicon, oxygen, and often carbon and hydrogen, based on the general empirical formula of R₂SiO, where R may be an alkyl group. Exemplary siloxanes include, but are not limited to, dimethylsiloxane, methylphenylsiloxane, methylhydrogen siloxane, methyltrimethoxysilane, octamethylcyclotetrasiloxane, hexamethyldisiloxane, diphenylsiloxane, and copolymers or blends of copolymers of any combination of monophenylsiloxane units, diphenylsiloxane units, phenylmethylsiloxane units, dimethylsiloxane units, monomethylsiloxane units, vinylsiloxane units, phenylvinylsiloxane units, methylvinylsiloxane units, ethylsiloxane units, phenylethylsiloxane units, ethylmethylsiloxane units, ethylvinylsiloxane units, or diethylsiloxane units.

In yet another aspect, the at least one functionalizing agent silanizes the at least one mineral filler, wherein the at least one surface treating agent is at least one silane. In general, silanes and other monomeric silicon compounds have the ability to bond inorganic materials, such as at least one mineral filler, to organic resins and materials, such as at least one active ingredient. The bonding mechanism may be due largely to two groups in the silane structure: the Si(OR₃) portion interacts with the at least one inorganic mineral filler, while the organofunctional (vinyl-, amino-, epoxy-, etc.) group interact with the at least one active ingredient.

In one aspect, at least one mineral filler is subjected to at least one surface treatment with a functionalizing agent comprising at least one ionic silane. Exemplary ionic silanes include, but are not limited to, 3-(thmethoxysilyl)propyl-ethylenediamine triacetic acid thsodium salt and 3-(thhydroxysilyl)propylmethylposphonate salt. In another aspect, the carrier material is subjected to at least one surface treatment with at least one nonionic silane. In a further aspect, the carrier material is subjected to at least one surface treatment with at least one silane of Formula (I):

(R¹)ₓSi(R²)₃₋ₓR³ (I)

wherein: R<1> is any hydrolysable moiety that may chemically react with any active group on the surface of the at least one mineral filler, such as but not limited to alkoxy, halogen, hydroxy, aryloxy, amino, amide, methacrylate, mercapto, carbonyl, urethane, pyrrole, carboxy, cyano, aminoacyl, or acylamino, alkyl ester, and aryl ester; X has a value between 1 and 3, such that more than one siloxane bond may be formed between the at least one mineral filler and the at least one silane; R² is any carbon-bearing moiety that does not substantially react or interact with the at least one mineral filler during the treatment process, such as but not limited to substituted or unsubstituted alkyl, alkenyl, alkaryl, alkcycloalkyl, aryl, cycloalkyl, cycloalkenyl, heteroaryl, heterocyclic, cycloalkaryl, cycloalkenylaryl, alkcycloalkaryl, alkcycloalkenyaryl, and arylalkaryl; R³ is any organic containing moiety that remains substantially chemically attached to the silicon atom of Formula (I) once the at least one surface treatment is completed and that is capable or reacting or interacting with the at least one active ingredient, such as but not limited to hydrogen, alkyl, alkenyl, alkaryl, alkcycloalkyl, aryl, cycloalkyl, cycloalkenyl, heteroaryl, heterocyclic, cycloalkaryl, cycloalkenylaryl, alkcycloalkaryl, alkcycloalkenyaryl, arylalkaryl, alkoxy, halogen, hydroxy, aryloxy, amino, amide, methacrylate, mercapto, carbonyl, urethane, pyrrole, alkyl ester, aryl ester, carboxy, sulphonate, cyano, aminoacyl, acylamino, epoxy, phosphonate, isothiouronium, thiouronium, alkylamino, quaternary ammonium, thalkylammonium, alkyl epoxy, alkyl urea, alkyl imidazole, or alkylisothiouronium; wherein the hydrogen of said alkyl, alkenyl, aryl, cycloalkyl, cycloalkenyl, heteroaryl, and heterocyclic is optionally substituted by, for example, halogen, hydroxy, amino, carboxy, or cyano.

In another aspect, at least one mineral filler with a hydroxyl-bearing porous surface is subjected to at least one surface treatment with a functionalizing agent comprising at least one silane, such that the material surface is covalently bonded to the at least one silane. In such an aspect, the surface area of the at least one mineral filler may limit the amount of the bound silane and, as a result, it may be preferable to subject the carrier material to at least one physical surface treatment that increases the surface area of the carrier material prior to treatment with the at least one silane.

In a further aspect, the at least one mineral filler is subjected to at least one surface treatment with a functionalizing agent comprising at least one silane having one or more moieties selected from the group consisting of alkoxy, quaternary ammonium, aryl, epoxy, amino, urea, methacrylate, imidazole, carboxy, carbonyl, isocyano, isothiohum, ether, phosphonate, sulfonate, urethane, ureido, sulfhydryl, carboxylate, amide, pyrrole, and ionic.

In addition to the functionalizing agent, the at least one mineral filler may also be treated with at least one active ingredient to impart a desired characteristic. At least one active ingredient may bind to or otherwise interact with the surface treated mineral fillers made according to the present invention. In one aspect, the surface treated mineral filler absorbs the at least one active ingredient. In another aspect, the surface treated mineral filler bonds to the at least one active ingredient.

The at least one active ingredient may take any of various forms and fulfill any of various functions. In one aspect, the at least one active ingredient is any substance that will bind to or otherwise interact with at least one mineral filler that has been subjected to at least one surface treatment. In another aspect, the at least one active ingredient is any substance that will bind to or otherwise interact with at least one mineral filler that has been subjected to at least one surface treatment, the activated product of which is useful as an additive to the final rubber composition.

In one aspect, the at least one active ingredient is at least one biocide. Exemplary classes of biocides include, but are not limited to, germicides, bactericides, fungicides, algaeicides, rodenticides, avicides, molluscicides, piscicides, insecticides, acahcides and products to control other arthropods, disinfectants, human hygiene biocidal products, private area and public health disinfectants, veterinary hygiene biocidal products, food and feed area disinfectants, drinking water disinfectants, pest repellants, pest attractants, antifouling products, embalming fluids, taxidermist fluids, and vertebrate control biocides.

Exemplary biocides includes, but are not limited to, neem oil, isothiazolinones, silver oxides, silver salts (e.g., silver halogenide, silver nitrate, silver sulfate, silver carboxylates (e.g., silver acetate, silver benzoate, silver carbonate, silver citrate, silver lactate, silver salicylate)), copper oxides, copper salts (e.g., copper sulfide, copper nitrate, copper carbonate, copper sulfate, copper halogenides, copper carboxylates), zinc oxides, zinc salts (e.g., zinc sulfide, zinc silicate, zinc acetate, zinc chloride, zinc nitrate, zinc sulfate, zinc gulconate, zinc lactate, zinc oxalate, zinc iodate, zinc iodide), iodopopargyl butyl carbamate, aldehydes, formaldehyde condensates, thazines (e.g., 1,3,5-tris-(2-hydroxyethyl-1,3,5-hexahydrotriazine)), dazomet (e.g., 3,5-dimethyl-2H-1,3,5-thiadiazinane-2-thione), glutaraldehyde (e.g., 1,5 Pentanedial), phenolics, carbonic acid esters, surfactant for hypochlorite (commercially available as Accepta 8001 from Accepta™ Advanced Chemical Technologies), bronopol (10%) (such as Accepta 8004 available from Accepta™ Advanced Chemical Technologies), chlorine release tablets, TriChloroisocyanurate (such as Accepta 8005 available from Accepta™ Advanced Chemical Technologies), DiChloroisocyanurate Granules (such as Accepta 8007 available from Accepta™ Advanced Chemical Technologies), Air Hygiene Biocide (such as Accepta 8008 available from Accepta™ Advanced Chemical Technologies), Multifunctional Chlorine Tablets, DiChloroisocyanurate (such as Accepta 8009 available from Accepta™ Advanced Chemical Technologies), Bio-Dispersant (Oil Fouling) for Cooling Water Systems (such as Accepta 8010 available from Accepta™ Advanced Chemical Technologies), Eco-Friendly Biocide based on Hydrogen Peroxide & Silver (such as Accepta 8101 available from Accepta™ Advanced Chemical Technologies), Hard Surface Cleaner and Surfactant, Hydrogen Peroxide/Silver (such as Accepta 8102 available from Accepta™ Advanced Chemical Technologies), Tablets for Air Conditioning Systems (such as Accepta 8205 available from Accepta™ Advanced Chemical Technologies), Chlorine Dioxide Tablets (such as Accepta 8502, Accepta 8505, and Accepta 8510, each available from Accepta™ Advanced Chemical Technologies Stabilised Chlorine Dioxide in Solution (I OOOppm) (such as Accepta 8520 available from Accepta™ Advanced Chemical Technologies), 2 Part Chlorine Dioxide Powder—0.3% solution in 25 L (such as Accepta 8551 available from Accepta™ Advanced Chemical Technologies), 2 Part Chlorine Dioxide Powder—0.3% solution in 100 L (such as Accepta 8552 available from Accepta™ Advanced Chemical Technologies), 2 Part Chlorine Dioxide Powder—0.3% solution in 1000 L (such as Accepta 8553 available from Accepta™ Advanced Chemical Technologies), THPS (such as Accepta 2102 available from Accepta™ Advanced Chemical Technologies), Glutaraldehyde (such as Accepta 2103 available from Accepta™ Advanced Chemical Technologies), Sodium Bromide Solution (40%) (such as Accepta 2104 available from Accepta™ Advanced Chemical Technologies), Isothiazoline (such as Accepta 2113 available from Accepta™ Advanced Chemical Technologies), Biocide for Cooling Water Systems (such as Accepta 2301 available from Accepta™ Advanced Chemical Technologies), Biodegradable Biocide for Cooling Water Systems (such as Accepta 2302 available from Accepta™ Advanced Chemical Technologies), Bio-dispersant for Cooling Water Systems (such as Accepta 2306 available from Accepta™ Advanced Chemical Technologies), 1.5% Isothiazoline, (such as Accepta 2027 available from Accepta™ Advanced Chemical Technologies), DBNPA, 2,2-DiBromo 3-Nitrilo Prophonamide (such as Accepta 2028 available from Accepta™ Advanced Chemical Technologies), Hypochlorite plus Surfactant to Penetrate Biofilms (such as Accepta 2029 available from Accepta™ Advanced Chemical Technologies), 5% Chlorite for Chlorine Dioxide Generators (such as Accepta 2055 available from Accepta™ Advanced Chemical Technologies), 8% Chlorite for Chlorine Dioxide Generators (such as Accepta 2056 available from Accepta™ Advanced Chemical Technologies), 25% Chlorite for Chlorine Dioxide Generators (such as Accepta 2057 available from Accepta™ Advanced Chemical Technologies), Bromine Tablets (BCDMH) (such as Accepta 2073 available from Accepta™ Advanced Chemical Technologies), Biodispersant (such as Accepta 2075 available from Accepta™ Advanced Chemical Technologies), Stabilised Bromine (Activated) (such as Accepta 2078 available from Accepta™ Advanced Chemical Technologies), 3% isothiazolin (such as Accepta 2086 available from Accepta™ Advanced Chemical Technologies), Quaternary Biocide, Ammonium based plus Antifoam (such as Accepta 2087 available from Accepta™ Advanced Chemical Technologies), 0.5% Isothaizoline (such as Accepta 2093 available from Accepta™ Advanced Chemical Technologies), Bacteria Anti-foulant for Marine Cooling Water Systems (such as Accepta 3553 available from Accepta™ Advanced Chemical Technologies), Rapid Dissolving Micro-Chlorine Tablets (such as Accepta 9010 available from Accepta™ Advanced Chemical Technologies), Multifunctional Chlorine Tablets (20 Og) (such as Accepta 9011 available from Accepta™ Advanced Chemical Technologies), amides (e.g., N(3,4-dichlorophenyl)-N,N-dimethyl urea), carbamates (e.g., methyl-N-benzimidazol-2-methylcarbamate), thiocarbamates, thiocyanates, dibenzamidines, pyridine derivatives, thazoles, thiazoles, isothiazolones, (e.g., 2-methyl-4-isothiazolin-3-one), N-haloalkylthio compounds (e.g., N-dichlorofluoromethylthiophthalimide), a blend of 2-Methyl-4-isothiazolin-3-one (MIT) and 5-Chloro-2-methyl-4-isothiazolin-3-one (CIT) known as CIT/MIT, a combination of CIT/MIT and hydroxymethyl ureide derivatives (such as Acticide® FI(N) and Acticide® FS(N)), a combination of CIT/MIT and formaldehyde (such as Acticide® HF), a combination of CIT/MIT and bronopol monovalent stabilized (such as Acticide® LA), aqueous formulations of MIT, BIT, and hydroxymethyl ureide derivatives (such as Acticide® MBF), aqueous formulations of MIT/BIT Novel CIT (such as Acticide® MBS), sodium nitrate stabilized bivalent metal free aqueous CIT/MIT formulation (such as Acticide® MV), magnesium and copper stabilized aqueous CIT/MIT formulation (such as Acticide® RS), magnesium nitrate stabilized aqueous CIT/MIT formulation (such as Acticide® SPX), and a combination of bacticides and fungicides in aqueous solvent based and powder form (such as Acticide® TBW, Acticide® TBS, and Acticide® TBP). In one aspect, the at least one active ingredient is Neem oil. In another aspect, the at least one active ingredient is an isothiazolinone. Exemplary isothiazolin-3-ones include, but are not limited to, 2-methyl-4-isothiazolin-3-one, 2-ethyl 4-isothiazolin-3-one, 2-propyl-4-isothiazolin-3-on, 2-butyl-4-isothiazolin-3-one, 2-amyl-4-isothiazolin-3-one, 5-chloro-2-methyl-4-isothiazolin-3-one, 5-bromo-2-methyl-4-isothiazolin-3-one, 5-iodo-2-methyl-4-isothiazolin-3-one, 5-chloro-2-butyl-4-isothiazolin-3-one, 5-bromo-2-ethyl-isothiazoline-3-one, 5-iodo-2-amyl-4-isothiazolin-3-one, 1,2-benzisothiazolin-3-one, 2-n-octyl-4-isothiazolin-3-one, 4,5-dichloro-2-n-octyl-4-isothiazolin-3-one and other similar analogues and homologues within the genus. Other exemplary biocides are listed in Commission Regulation (EC) No. 1048/2005 of 13 Jun. 2005 from the Official Journal of the European Union, which is incorporated by reference herein in its entirety.

In one aspect, the at least one active ingredient is chosen from a group consisting of halogenated biocides. Exemplary halogenated biocides include, but are not limited to, 2,2-Dibromo-3-nitrilopropionamide (DBNPA), 2-Bromo-2-nitropropene-1,3-diol (BNPD), 3-iodo-2-propynylbutyl carbemate (IPBC), Chlorohexidine gluconate, chloroisocyanurates, chlorothalonil, halogenated hydantoins, and iodophors.

In another aspect, the at least one active ingredient is chosen from a group consisting of inorganic biocides. Exemplary inorganic biocides include, but are not limited to, cuprous oxide and inorgano-silver.

In yet another aspect, the at least one active ingredient is chosen from a group consisting of nitrogen-based biocides. Exemplary nitrogen-based biocides includes, but are not limited to, N-(3,4-dichlorophenyl)-N′,N′-dimethylurea (diuron), methyene-bis-morpholine (MBM), quaternary ammonium compounds (quats), salicylamide, and thazines.

In still another aspect, the at least one active ingredient is chosen from a group consisting of organometallics. Exemplary organometallics include, but are not limited to, 10,10′-ozybisphenoxerside (OBPA), bis(tributyltin) oxide (TBTO), tributyltin-chloride (TBTC), and triphenyltin chloride (TPTC).

In another aspect, the at least one active ingredient is chosen from a group consisting of organometallic biocides. Exemplary organometallic biocides include, but are not limited to, disodium ethylenebis, dithiocarbemate, potassium dimethyldithiocarbamate, sodium dimethyldithiocarbamate, 1,2-benzisothiaxolin-3-one, 5-chloro-2-methyl-4-isothiazolin-3-one and 2-methyl-4-isothiazolin-3-in-one (CIT/MIT), 4,5 dichloro-2-n-octyl-4-isothiazolin-3-one (DCOIT), 2-n-octyl-4-isothiozolin-3-one (OIT), N-butyl-1,2-benzisothiazolin-3-one (BBIT), zinc-2-pyridinethiol-2-oxide (ZPT), methylenebis (tiocyanate) (MBT), 2-(thiocyanomethylthio)benzothiazole (TCMTB), tetrahydro-3,5-dimethyl-2H-1,3,5-thiadiazine-2-thione (thione), (5-chloro-2,4-dichlorophenoxyl) phenol (triclosan), o-Phenylphenol (OPP), glutaraldehyde, and peracetic acid.

In yet another aspect, the at least one active ingredient is chosen from a group consisting of phenolic biocides. Exemplary phenolic biocides include, but are not limited to, (5-chloro-2,4-dichlorophenoxyl) phenol (triclosan), 3,4,4′-trichlorocarbanilide (triclocarban), o-Benzo-p-chlorophenol (OBCP), o-phenylphenol (OPP), pentachlorophenol (PCP), phenoxyethanol, and p-hydroxybenzoates (parabens).

In another aspect, the at least one active ingredient is chosen from the group consisting of antimicrobial agents and preservatives. Exemplary antimicrobial agents and preservatives include, but are not limited to, in-can preservatives, film preservatives, wood preservatives, fibre preservatives, leather preservatives, rubber preservatives, polymerized materials preservatives, masonry preservatives, liquid cooling system preservatives, processing system preservatives, slimicides, metalworking-fluid preservatives, food preservatives, feedstock preservatives, phenoxyethanol, triclosan, 7-ethylbicyclooxazolidine, benzoic acid, bronopol (e.g., 2-bromo-2-nitropropane-13-diol), butylparaben, chlorite, chlorphenesin, diazolidinyl urea, dichlorobenzyl alcohol, dimethyl oxazolidine, DMDM hydantoin, ethylparaben, hexamidine diisethionate, imidiazolidinyl urea, imidiazolidinyl urea NF, iodopropynyl butylcarbamate, isobutylparaben, methylparaben, potassium sorbate NF FCC, propylparaben, quaternium-15, sodium benzoate NF FCC, sodium caprylate, sodium dehydroacetate, sodium dehydroacetate FCC, sodium hydroymethylglycinate, sodium hydroxymethylglycinate, sodium methylparaben, sodium propylparaben, sorbic acid NF FCC, anisic acid, benzethonium chloride, caprylic/caphc glycerides, caprylyl glycol, di-alpha-tocopherol, ethylhexylglycerin, glyceryl caprate, methyl isothiazolinone, polymethoxy bicyclic oxazolidine, Tocopheryl acetate, alcohol, benzalkonium chloride, benzethonium chloride, camellia sinensis leaf extract, Candida bombicola/glucose/methyl rapeseedate, hydrogen peroxide, methylbenzethonium chloride phenol, pinus pinaster bark extract, Poloxamer 188, PVP-Iodine, Rosmarinus officinalis Leaf extract, Vitis vinifera seed extract, ammomium benzoate, ammonium propioante, 5-Bromo-5-nitro-1,3-dioxane, Chloroxylenol, Ethyl alcohol, Glutaral, Iodopropynyl butylcarabamate, Isothiazolinone, Parabens, Pircotone olamine, Selenium disulphine, Sorbic acid (mold), Zinc pyhthione, Benzalkonium chloride, Benzethonium chloride, Benzoic acid, Dehydroacetic acid, Dimethyl hydroxmethylpyrazole, Formaldehyde, Hexetidine, Methyldibromo glutaronithle, Salicylic acid, Sodium hydroxymethylglycinate, Sodium iodate, Zinc oxide, Benzyl alcohol (mould), Boric acid (yeast), Chloroacetamide, Phenoxythanol, Orthophenylphenol, Benzalkonium chloride, Benzethonium chloride, 5-Bromo-5-nitro-1,3-dioxane, Bronopol, Diazolidinyl urea, Dimethyl hydroxmethylpyrazole, Dimethyl oxazolidine, DMDM hydantoin, Ethyl alcohol, 7-Ethyl bicycloxazolidine, Glutaral, Imidazolidinyl urea, Isothiazolinone, Methenammonium chloride, Methylbromo glutaronitrile, Polymethoxy bicylooxazolidine, Quaternium-15, Sodium hydroxymethylglycinate, Thimersal, Benzoic acid, Benzyl alcohol, Chlorhexidine, Hexetidine, Phenethyl alcohol, Polyaminopropyl biguanide, Polyquarternium-42, Salicylic acid, Sodium iodate, Thclocarban, Zinc phenolsulphonate, Chloroacetamide, Chlorobutanol, Dehydroacetic acid, Neem seed oil, Phenoxyethanol, Tee trea oil, Usnic acid, Ammonium Benzoate, Ammonium Propionate, Benziosthiazolinone, Benzoic Acid, Benzothazole, Benzyl Alcohol, Benzylhemiformal, Benzylparaben, 5-Bromo-5-Nitro-1,3-Dioxane, 2-Bromo-2-Notropropane-1,3-Diol, Butyl Benzoate, Butylparaben, Calcium Benzoate, Calcium Paraben, Calcium Propionate, Calcium Salicylate, Calcium Sorbate, Captan, Chloramine T, Chlorhexidine Diacetate, Chlorhexidine Digluconate, Chlorhexidine Dithydrochloride, Chloroacetamine, Chlorobutanol, p-Chloro-m-Cresol, Chlorophene, p-Chlorophenol, Chlorothymol, Chloroxylenol, Citrus Grand is (Grapefruit) Fruit Extract, Citrus Grand is (Grapefruit) Seed Extract, Copper Usnate, m-Cresol, o-Cresol, p-Cresol, DEDM Hydantoin, DEDM Hydantoin Dilaurate, Dehydroacetic Acid, Diazolidinyl Urea, Dibromopropamidine Diisethionate, Dimethyl Hydroxymethyl Pyrazole, Dimethylol Ethylene Thiourea, Dimethyl Oxazolidine, Dithiomethylbenzamide, DMDM Hydantoin, DMHF, Domiphen Bromide, Ethyl Ferulate, Ethylparaben, Ferulic Acid, Glutaral, Glycerol Formal, Glyoxal, Hexamidine, Hexamidine Diparaben, Hexamidine Paraben, 4-Hydroxybenzoic Acid, Hydroxymethyl Dioxazabicyclooctane, Imidazolidinyl Urea, Iodopropynyl Butylcarbamate, Isobutylparaben, Isodecylparaben, Isopropyl Cresols, Isopropylparaben, Isopropyl Sorbate, Magnesium Benzoate, Magnesium Propionate, Magnesium Salicylate, MDM Hydantoin, MEA-Benzoate, MEA o-Phenylphenate, M EA-Salicylate, Methylchloroisthiazolinone, Methyldibromo Glutaronitrile, Methylisothazolinone, Methylparaben, Mixed Cresols, Nisin, PEG-5 DEDM Hydantoin, PEG-15 DEDM Hydantoin, PEG-5 Hydantoin Oleate, PEG-15 DEDM Hydantoin Stearate, Phenethyl Alcohol, Phenol, Phenoxyethanol, Phenoxyethylparaben, Phenoxyisopropanol, Phenyl Benzoate, Phenyl Mercuric Acetate, Phenyl Mercuric Benzoate, Phenyl Mercuric Borate, Phenyl Mercuric Bromide, Phenyl Mercuric Chloride, Phenylparaben, Polyaminopropyl Biguanide, Polyaminopropyl Biguanide Stearate, Polymethoxy Bicyclic Oxazolidine, Polyquaternium-42, Potassium Benzoate, Potassium Ethylparaben, Potassium Methylparaben, Potassium Paraben, Potassium Phenoxide, Potassium o-Phenylphenate, Potassium Propionate, Potassium Propylparaben, Potassium Salicylate, Potassium Sorbate, Propionic Acid, Propyl Benzoate, Propylparaben, Quaternium-8, Quatemium-14, Quatemium-15, Silver Borosilicate, Silver Magnesium Aluminium Phosphate, Sodium Benzoate, Sodium Butylparaben, Sodium p-Chloro-m-Cresol, Sodium Dehydroacetate, Sodium Ethylparaben, Sodium Formate, Sodium Hydroxymethane Sulfonate, Sodium Hydroxymethylglycinate, Sodium Isobutylparaben, Sodium Methylparaben, Sodium Paraben, Sodium Phenolsulfonate, Sodium Phenoxide, Sodium o-Phenylphenate, Sodium Propionate, Sodium Propylparaben, Sodium Pyrithione, Sodium Salicylate, Sodium Sorbate, Sorbic Acid, TEA-Sorbate, Thimerosal, Triclocarban, Thclosan, Undecylenoyl PEG-5 Paraben, Zinc Pyrithione or combinations thereof, such as for example Benzyl Alcohol/methylchloroisothiazolinone/methylisothiazolinone, Benzyl alcohol/PPG-2 methyl ether/bronopol/deceth-8/iodopropynyl/butylcarbamate, Chloroacetamide sodium benzoate, Dehydroacetic acid/benzyl alcohol, Diazolidinyl urea/iodopropynyl butylcarbamate, Diazolidinyl urea/methylparaben/ethylparaben/butylparaben/propylparaben/isobutylparabe-n/2-phenoxyethanol, DMDM hydantoin/iodopropynyl butylcarbamate, Glycerin/water/ethoxdiglycol/caprylyl glycol/sodium polyacrylate, Glyceryl laurate/caprylyl/phenylpropanol/dipropylene glycol, imidazole, Isopropylparaben/isobutylparaben/butylparaben, Methyl chloroisothiazolinone/methyl isothiazolinone, Methyldibromo glutaronithle/methylchloroisothiazolinone/methylisothiazolinone/phenoxye-thanol, Methyldibromo glutaronithle/phenoxyethanol, Methylchloroisothiazolinone/methylisothiazolinone, Methylparaben/ethylparaben/butylparaben/propylparaben/butylenes glycol, Methylparaben/ethylparaben/butylparaben/propylparaben/isobutylparaben, Methylparaben/ethylparaben/butylparaben/propylparaben/isobutylparaben/2-p-henoxy-ethanol/bronopol, Methylparaben/ethylparaben/butylparaben/propylparaben/1,3-butylene glycol isomer, Methylparaben/propylparaben, Methylparaben/propylparaben/benzyl alcohol, Methylparaben/propylparaben/bronopol/phenoxyethanol, Methylparaben/propylparaben/bronopol/propylene glycol, Methylparaben/propylparaben/ethylparaben, Methylparaben/propylparaben/propylene glycol/diazolidinyl urea, oxazolidines, 2-phenylphenol, 2,4,4′-trichloro-2′-hydroxy diphenol ether, diiodomethyl-p-tolylsulfone, N-alkyl-N,N-dimethyl-N-benzylammonium chloride, zinc 2-mercaptopyridine-N-oxide, Phenoxyethanol/benzoic acid/dehydroacetic acid, Phenoxyethanol/benzyl alcohol/potassium sorbate/tocopherol, Phenoxylethanol/chlorphenesin/glycerin/methylparaben/benzoic acid, Phenoxyethanol/DMDM hydantoin/Iodopropynyl butyl carbamate, Phenoxyethanol/DMDM hydantoin/methylparaben/propylparaben, Phenoxyethanol/isopropylparaben/isobutylparaben/butylparaben, Phenoxyethanol/methyldibromo glutaronitrile/idopropynyl butylcarbamate, Phenoxyethanol/methylparaben/butylparaben/ethylparaben/propylparaben, Phenoxyethanol/methylparaben/butylparaben/ethylparaben/propylparaben/isob-utyl-paraben, Phenoxyethanol/methylparaben/isobutylparaben/butylparaben, Phenoxythanol/triethylene glycol/dichlorobenzyl alcohol, Polyaminopropyl biguanide/parabens/phenoxyethanol, PPG-2 methyl ether/sodium benzoate/potassium sorbate/iodopropynyl butylcarbamate, Propylene glycol/benzyl alcohol/methylchloroisothiazolinone/methylisothaizolinone, Propylene glycol/diazolidinyl urea/iodopropynyl butylcarbamate, Propylene glycol/diazolidinyl urea/methylparaben/propylparaben, Propylene glycol/MDMD hydantoin/methylparaben, Propylene glycol/MDMD hydantoin/methylparaben/propylparaben, Propylene glycol/lichen extract, Propylene glycol/phenoxyethanol/chlorphenesin/methylparaben, and Sodium levulinate/phenylpropanol combinations.

In general, natural gloves can be manufactured as follows:

Rubber tree latex is collected from a rubber tree, and preservatives such as ammonia and thiurams are added to prevent microbial degradation of the latex. The latex is then subjected to centrifugation to concentrate the latex and to remove some of the contaminating proteins.

Following centrifugation, various chemicals can be added, including accelerators (which help control the later vulcanization process) and antioxidants (which prevent deterioration of the rubber molecules in the final product by heat, moisture and ozone). Some accelerators (thiurams, mercaptobenzothiazole, carbamate, thioureas) are known as Type IV allergens. Thiurams are can also act as sensitizing agents, and many manufacturers now replace thiurams with dithiocarbamates as the accelerators of choice.

A specific exemplary formulation is as follows:

| Ingredients: | Parts by Weight |
|---|---|
| Natural rubber (as latex) | 100.00 |
| Potassium hydroxide | 0.10 |
| Stabilizer (e.g. isopropyl naphthyl sodium sulfonate) | 0.35 |
| Formaldehyde (37%) | 2.90 |
| Zinc diethyldithiocarbamate | 0.10 |
| Sulfur | 0.40 |
| Zinc salt of mercaptobenzothiazone | 0.50 |
| Zinc oxide | 0.10 |
| Clay | 10.00 |
| Symmetrical dibeta naphthyl-p-phenylene diamine | 1.00 |

Water, as needed to bring total solids to 60%.

Once the latex has been prepared, the gloves are then formed by coating hand shaped formers with coagulant (e.g., calcium nitrate) and dipping them into the latex to coat them with a thin film of latex. The coagulant converts the liquid latex film into a wet-gel on the former. Subsequent passage through a warm oven completes the coagulation process.

The formed gloves can then be subjected to as process known as “wet gel leaching”, in which they are immersed into a bath or spray of water to wash out excess additives from previous stages. Chemical and protein content can be reduced at this stage, but the effectiveness of the process is dependent on the temperature of the water, the duration of the process, and the rate of water exchange.

The gloves can then be vulcanized by heat treatment. In this stage, the latex film is heated, and the combination of sulphur, accelerator and heat cause cross-linking of the rubber, giving strength and elasticity to the film. The vulcanized gloves are then removed from the formers by turning them inside out. A second leaching step can be preformed at this point, followed by drying.

The dry gloves can then be lubricated to enable easy donning by tumbling the gloves in a slurry of starch and biocide. Starch has been shown to bind to the latex proteins, and can act as a vector for transfer of the protein to the skin or to the lungs (as an airborne dust). Accordingly, instead of powdering, some manufacturers dip their gloves into a chlorinated solution to make the glove surface slippery

The finished gloves are often then tested for integrity and pin holes by air inflation or by a water based test method. This is generally the last stage before the gloves are distributed to the user.

In another aspect, the above process can easily be adapted to make gloves made from synthetic latex by simply substituting a suitable synthetic latex polymer or blend of polymers for the natural latex described above. Examples of synthetic latex polymers can include styrene-butadiene rubber, acrylonitrile butadiene styrene, acrylic polymers and polyvinyl acetate.

Use of a functionalized mineral filler as described herein can provide for a beneficial reduction in volatile odor causing organic and aromatic compounds in both natural and synthetic latex products.

In an exemplary aspect, the present invention can include a polyvinylpyrrolidone functionalized diatomite in a natural latex. Polyvinylpyrrolidone is capable of forming complexes with a broad variety of compounds, and can be used as a complexing agent for modifying resins. PVP's good compatibility and crosslinking properties make it highly suitable for use in binding to proteins and thereby reducing extractable proteins.

The high porosity of diatomite is thought to serve as a carrier for the polyvinylpyrrolidone. Because diatomite's high silica content causes it to migrate to the surface of the rubber, it is hypothesize that the polyvinylpyrrolidone is also concentrated at the surface and is thus highly available for complexation. Further, DE's propensity of migrating to the surface should also serve as a mold-release lubricant which would enable easier removal of latex gloves from the mold.

Many other modifications and variations of the aspects of the invention as hereinbefore set forth can be made without departing from the spirit and scope thereof. Other than in the examples, or where otherwise indicated, all numbers expressing quantities of ingredients, reaction conditions, and so forth used in the specification and claims are understood as being modified in all instances by the term “about.” Accordingly, unless indicated to the contrary, the numerical parameters set forth in the following specification and attached claims are approximations that may vary depending upon the desired properties sought to be obtained herein. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope are approximations, the numerical values set forth in the specific examples are reported as precisely as possible. Any numerical value, however, inherently contain certain errors necessarily resulting from the standard deviation found in their respective testing measurements.

The headers used in this specification are presented for the convenience of the reader and not intended to be limiting of the inventions described herein. By way of non-limiting illustration, concrete examples of certain aspects of the present disclosure are given below.

### EXAMPLES

Filter-aid materials comprising at least one composite filter-aid as disclosed herein, as well as methods for preparing them, are described in the following examples, which are offered by way of illustration and not by way of limitation.

### Example 1

A clean glove form was used to make conventional surgeon's gloves from natural latex rubber by dipping the form into an aqueous natural rubber latex composition made by mixing 3 parts by weight of a conventional natural rubber latex in 2 parts by weight of water (i.e., 60% solids). The following chemicals were then added to the latex mixture: 0.15-0.4 phr stabilizer (KOH/Potassium Laurate/Ammonium Laurate), 15-30 phr calcium carbonate (Carbital N500/N770, available from Imerys), 0.8-1.2 phr sulfur, 0.5-0.8 phr ZnO, 0.25-0.55 phr ZDEC and 0.25-0.4 phr ZDBC as accelerant, 0.5-0.9 phr Lowinox CPL as an antioxidant, 0.2-0.5 phr TiO2 as a colorant, and 0.05-0.1 phr FS EPL as antifoaming agent. The total solids content was adjusted to approximately 18%-24% prior to dipping by addition of soft water.

The form was then dipped into coagulant solution comprising calcium nitrate, removed and allowed to dry at room temperature approximately two to three minutes. The form was then again dipped into the natural rubber latex for a dwell time, for example ranging from 5 to 10 seconds. The form was dipped into the coagulant again, removed and allowed to dry at room temperature approximately two to three minutes.

Proteins were extracted and measured according to standard ASTM D5712-05 in a modification of the Lowry assay. The Lowry test method as modified for the analysis of protein in NRL is currently the only method recognized by the FDA and by ASTM for determination of protein levels in gloves.

In general, the Lowry test method used involves the reaction of latex protein with alkaline copper tartrate and the subsequent reaction of the protein-copper tartrate complex with Folin reagent, which results in a blue color detectable via absorbance at 280 nm in a UV spectrophotometer. In the modified Lowry assay (ASTM D5712-05) as it applies to the detection of latex proteins, these proteins are first precipitated in order to remove interfering, water-soluble substances, and the Lowry assay is performed only after the protein precipitation and reconstitution step.

The results are presented in Table 1.

TABLE 1

| | | Protein Level |
|---|---|---|
| Sample | | (μg/g) |
| 1 | Control (without treated | 37-145 |
| | diatomite) | |
| 2 | With 1.5 phr and 3.0 phr | 0-13 |
| | loading of treated diatomite | |

As can be seen in Table 1, the addition of 1.5 to 3.0 phr treated diatomite results in a large reduction of extractable protein.

### Example 2

Sample 4 includes approximately 3 phr of a functionalized diatomite prepared by mixing 25 gm of diatomite (Microcel® E, available from Celite Corp.) and 100 gm of distilled water. The slurried diatomaceous earth was functionalized by addition of 31.3 gm (25.05 gm active) of AQ7550 (Dimethylol, 80% active in water, obtained from INEOS Melamines) while stirring, followed by stirring for an additional 30 min. The resulting slurry dried to constant weight @ 105° C. and then milled to smaller particle size.

Sample 3 includes approximately 3 phr of a functionalized diatomite prepared by mixing 25 gm of diatomite (CelTix®, available from Celite Corp.) and 100 gm of distilled water. The slurried diatomaceous earth was functionalized by addition of 55.6 gm (25.05 gm active) of a 60 kDalton polyvinylpyrrolidone (PVP K-60, 45% solids in water, obtained from International Specialty Products) while stirring, followed by stirring for an additional 30 min. The resulting slurry dried to constant weight @ 105° C. and then milled to smaller particle size.

Samples 3, 4 and the control were compounded as follows. A two-step mixing procedure was used. Royalene and SP-1055 were first mixed in a Banbury mixer @ 210-220° C. for 5 min to allow intimate mixing of phenolic resin curative and EPDM (a synthetic ethylene propylene diene Monomer (M-class) rubber, available from Lion Copolymer LLC). Polypropylene (PP) and the treated filler was added next and mixed @ 330-350° C. at high shear to melt PP, disperse the resin containing rubber in PP, and cure the rubber.

The above compounded material (TPV) was wrapped in polyethylene film to minimize loss of volatiles during storage and prior to sampling for headspace analysis of odor causing volatiles.

Volatile compound emission was measured via gas chromatography and mass spectrometry to assess odorant levels in natural latex rubber compositions with and without the functionalized mineral filler. A portion of each of the three samples was cut in to small pieces (2.65-2.66 gm) and placed in a 10 mL glass vial that was tightly sealed with aluminum foil and a crimp cap. The samples were then placed in the oven at 100° C. for one hour to drive the volatile materials in to the head space. A gas syringe was used to collect 1.0 cc of headspace material that was analyzed via GC/MS (Agilent 6890 GC/5973MSD, Column: Poly(5% diphenyl/95% dimethylsiloxane).

The results are presented in Table 2.

TABLE 2

| Ingredients | Control | Sample 4 | Sample 5 |
|---|---|---|---|
| Royalene 525 (EPDM-from | 40 | 40 | 40 |
| LION CoPolymer Geismar | | | |
| Group) | | | |
| SP-1055 (Brominated Phenolic | 4 | 4 | 4 |
| Resin-from SI Group) | | | |
| Profax 6523 (Polypropylene) | 60 | 60 | 60 |
| Treated Microcel E | | 3 | |
| Treated CelTiX | | | 3 |
| Volatile Components | | | |
| 2,4,4-Trimethyl Pentene | 3.40E+06 | 2.50E+06 | 2.05E+06 |
| o-Xylene | 2.50E+06 | 1.40E+06 | 1.20E+06 |
| Bicyclo[2,2,1]hept-2-ene,5- | 3.10E+06 | 2.10E+06 | 1.18E+06 |
| ethylidene | | | |

As can be seen in Table 1, the addition of 3.0 phr treated diatomite results in a significant reduction of volatiles for both treatment with PVPP and melamine.

1-73. (canceled)

74. A rubber composition comprising a natural latex and a functionalized mineral filler, wherein said rubber has a soluble aqueous protein content of less than about 100 micrograms per gram as measured in accordance with ASTM D5712.

75. The rubber of claim 74, wherein said mineral filler comprises diatomite.

76. The rubber of claim 74, wherein said mineral filler comprises perlite.

77. The rubber of claim 74, wherein said mineral filler comprises clay.

78. The rubber of claim 74, wherein said mineral filler comprises kaolin.

79. The rubber of claim 74, wherein said mineral filler comprises mica.

80. The rubber of claim 74, wherein said mineral filler is selected from the group consisting of wollastonite, amorphous silicas, amorphous aluminas, alumina trihydrate, barite, Barium Sulfate, ground calcium carbonate, precipitated calcium carbonate, calcium sulfate, gypsum, carbon black, clay, chlorite, dolomite, feldspar, graphite, huntite, hydromagnesite, hydrotacite, magnesia, magnesite, magnesium carbonate, magnesium hydroxide, magnetite, Fe₃O₄, nepheline syenite, olivine, pseudoboehmites, forms of microcrystalline aluminum hydroxide, pyrophyllite, smectites, bentonite, montmorillonite, resins, titania, titanium dioxide, rutile, waxes, zeolites, Y-zeolites, dealuminated Y-zeolites, and zinc oxide.

81. The rubber of claim 74, wherein said functionalized mineral filler is present in an amount ranging from about 0.5 phr to about 10 phr.

82. The rubber of claim 74, wherein said functionalized mineral filler is present in an amount ranging from about 1 phr to about 5 phr.

83. The rubber of claim 74, wherein said functionalized mineral filler is present in an amount ranging from about 1 phr to about 3 phr.

84. The rubber of claim 74, wherein the functionalized mineral filler comprises a polymer as a functionalizing agent.

85. The rubber of claim 84, wherein the functionalized mineral filler comprises a polyvinylpyrrolidone as a functionalizing agent.

86. The rubber of claim 84, wherein the functionalized mineral filler comprises as a functionalizing agent a polymer selected from a melamine formaldehyde, and epichlorohydrin, a polyamine, or a polyamide.

87. The rubber of claim 74, wherein the functionalized mineral filler comprises precipitated silica or a precipitated silicate.

88. The rubber of claim 74, wherein the functionalized mineral filler comprises a silane or siloxane.

89. The rubber of claim 74, wherein said rubber has a soluble aqueous protein content of less than about 50 micrograms per gram as measured in accordance with ASTM D5712.

90. The rubber of claim 74, wherein said rubber has a soluble aqueous protein content of less than about 30 micrograms per gram as measured in accordance with ASTM D5712.

91. The rubber of claim 74, wherein said rubber has a soluble aqueous protein content of less than about 20 micrograms per gram as measured in accordance with ASTM D5712.

92. A method for decreasing the allergenicity of a natural latex comprising admixing a functionalized mineral filler with said natural latex.

93. A rubber composition comprising a natural or synthetic latex and a functionalized mineral filler, wherein said rubber has a volatile organic content of less than about 3.0×10⁶ as measured by GC/mass spectrometry.
